(19) United States
(12) Patent Application Publication
(10) Pub. No.: US 2014/0278973 A1
(43) Pub. Date: Sep. 18, 2014

(54) SYSTEM AND METHOD FOR AUDIENCE TARGETING

(71) Applicant: MaxPoint Interactive, Inc., (US)

(72) Inventors: Mark Lowe, Morrisville, NC (US); Andrew Cron, Durham, NC (US); Walter Elder, Austin, TX (US); Erika Bruger, Apex, NC (US); Igor Postelnik, Austin, TX (US)

(73) Assignee: MaxPoint Interactive, Inc., Morrisville, NC (US)

(21) Appl. No.: 13/843,276

(22) Filed: Mar. 15, 2013

(51) Int. Cl. G06Q 30/02

(52) U.S. Cl. CPC G06Q 30/0255
USPC 705/14.53

(57) ABSTRACT

A method and system for audience targeting is disclosed. According to one embodiment, a computer-implemented method comprises logging content consumed by a first group of users. The content is categorized into a set of topics. The set of topics are mapped to a plurality of users in a trade zone. Based on profile matching and according to a topic of an advertisement campaign, a second group of users are identified from the plurality of users.

### FIELD

The present disclosure relates in general to the field of computer software and systems, and in particular, to a system and method for audience targeting.

### BACKGROUND

Online advertisement placements generally refer to the slots or space on the pages of a website that are available for displaying advertisements along with its content. Advertisers typically bid on these advertisement placements that are made available through real-time bidding (RTB) exchanges such as AdX, Admeld, Pubmatic, etc.

This requires a bidding server to have computer hardware linked to the RTB exchanges. The bidding server then receives bid requests via the RTB exchanges. A bid request occurs when a user/internet surfer visits a website/publisher that is selling their advertisement space on an RTB exchange. Upon receiving a bid request, the bidding server has a very short period of time to respond to this request (generally around 50-100 ms or less). Since this bid response needs to occur in a very short period of time, it is difficult to run large scale models to predict what advertisements to buy and what price to pay for them.

Traditionally, an advertiser manually makes simple static rules to be carried out at bid time. The advertiser observes and determines which domains are available on the exchanges. The advertiser selects the domains to bid on manually. After several days, the advertiser receives a report and visually weighs each domain against its click-through-rate (“CTR”) to decide if the advertisement performed adequately. The CTR refers to the percentage of times users click on the advertisements given the number of times the advertisements are displayed (“impressions”). The advertiser removes poor performing domains and adds new domains. This traditional approach is a process of trial and error that relies on human memory and human judgment to meet CTR goals and to ensure that sufficient domains are chosen for the campaign to meet the periodic impression quota. Therefore, this traditional approach is prone to human errors. Furthermore, since advertisers generally bid on domains with a single static price, they often pay too much for advertisement placements or do not win more valuable bids at the set price.

Finding, understanding, and targeting the optimal audience in a digital advertisement campaign are challenging tasks. Geographical targeting uses the contextual information of web pages on which advertisements are placed to understand and predict the behavior of users in a geographical area. There is a growing demand for identifying and classifying users who are most likely to respond to an advertisement campaign, thus having a high return on investment (ROI) instead of merely locating websites with unpredictable and immeasurable potential. The ability to target potential customers achieves cost effective marketing and provides precise understanding of the market for future advertisement campaigns.

In order to achieve optimal audience targeting, problems that arise from modeling and data management and reduction need to be addressed. After a conventional real-time bidding process for an advertisement campaign, data representing users' web consumption needs to be manageable and interpretable. Conventional contextual and behavioral targeting may not provide reliable prediction to identify potential users for advertisement placements. Advertisers need to understand what types of users are likely to buy their product and collect datasets to efficiently predict users' behavior while being able to detect and filter out intelligent bots from the obtained datasets.

### SUMMARY

A method and system for audience targeting is disclosed. According to one embodiment, a computer-implemented method comprises logging content consumed by a first group of users. The content is categorized into a set of topics. The set of topics are mapped to a plurality of users in a trade zone. Based on profile matching and according to a topic of an advertisement campaign, a second group of users are identified from the plurality of users.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 illustrates an exemplary system level architecture for use with the present system, according to one embodiment;

FIG. 2 illustrates an exemplary flow chart for collecting content consumed by users, according to one embodiment;

FIG. 3 illustrates an exemplary flow chart for audience targeting, according to one embodiment; and

FIG. 4 illustrates an exemplary computer architecture that may be used for the present system, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

A method and system for audience targeting is disclosed. According to one embodiment, a computer-implemented method comprises logging content consumed by a first group of users. The content is categorized into a set of topics. The set of topics are mapped to a plurality of users in a trade zone. The topics of logged content visited by the first group of users are aggregated into a user specific interest profile so that it significantly reduces the dimension of data. Based on profile matching and according to a topic of an advertisement campaign, a second group of users are identified from the plurality of users.

According to one embodiment, digital content sources include yet are not limited to web pages from websites providing data feeds, web pages associated with target requests, purchased website server logs, mobile applications, television programming transcripts (and other video sources), on-demand video selections, and email.

According to one embodiment, the present system and method provides learning, predicting and targeting at an individual level. According to another embodiment, the present system and method provides learning, predicting and targeting at groups of individuals or individuals in a geographic area smaller than a trade zone. Trade zones refer to custom defined shapes that have associated data sets and indicate various characteristics about the audience in those shapes. Targeting audience of a trade zone may generate satisfactory results when placing advertisements for general audience in a geographical area but it may not always yield the optimal results unless the characteristics of the audience is well known and predictable. Therefore, targeting audience at an individual level or a group of individuals who may not necessarily be in the same trade zone may result in more predictable and efficient results.

According to one embodiment, the present system and method allows for learning of the characteristics and interests of audience by collecting the digital content consumed and classifying the consumed digital content into interest categories. This reduces the digital content (e.g., web pages, video transcripts, email, mobile applications) linked to an individual into a series of scores by interest topics. These interest scores are aggregated to determine scores for a group of users, for example, at a trade zone level or smaller groups of user. The resultant table-like data structure yields a highly efficient way to store and process user attributes in targeting models.

According to another embodiment, the present system and method selects a specific set of users who take a positive action or any other performance metric, and determines common interest attributes to form a target profile success. The present system and method dynamically learns profiles for each campaign as well as users' successful actions such as clicks. In one embodiment, desired actions are logged by a user outside of the running of a digital advertisement campaign. For example, an advertiser may provide a list of users who have purchased products or signed up for promotions. In another embodiment, the individual and dynamical targeting during an advertisement campaign provides insights into performance prediction of an advertisement campaign based on profile learning. Therefore, targeting audience may be performed on an individual basis and/or in combination of targeting based on geographical areas or trade zones.

According to one embodiment, the present system and method provides performance metrics or actions of individuals rather than relying on performance prediction of trade zones. Based on historical offline data and/or online data of a currently running advertisement campaign, the system collects data and identifies users who respond well to a particular advertisement campaign. As more advertisement campaigns are run, the system builds an extensive database for users and their performance metrics. Moreover, this audience-based targeting allows the system to identify individuals who have not been previously served for a particular campaign but has a closely matching profile with users who are known to respond well to a particular advertisement campaign. Therefore, the present system does not utilize a retargeting mechanism that serves those users who took an action, but rather identifies new users who have similar audience profiles.

Audience targeting can be mixed with geographic or trade zone targeting to achieve highly scalable and highly predictable targeting. Individuals in the same geographical area or trade zone may have varying behavioral patterns or characteristics. However, individuals in remote geographical areas may not be efficiently identified because profile matching at an individual level may be costly, time-consuming, and computationally intensive. Audience targeting may be supplemented with geographical targeting, and users of similar profile and/or behavioral patterns may be grouped into smaller custom geographical areas for group targeting.

According to one embodiment, the present system and method continually updates the identification and classification of individuals during the course of a campaign. The system learns more about users who are interested in an advertisement campaign by response or positive actions (e.g., clicking, downloading a coupon, calling, and filling out an application). The learned information is used to identify other users who have not been previously served but are likely to respond well to the advertisement by users' profile matching. Exemplary profile attributes include classified web content, search queries, time patterns, history of taking various online actions, demographics and offline purchases. In one embodiment, profile matching runs a supervised learning model like gradient boosted regression trees. The learning and profile matching are unique for every advertisement campaign, though similar campaigns may be used to further identify the details of a targeting profile. As an example, a luxury automobile retailer may want to increase the number of test drives. A traditional behavioral targeting approach would be to purchase cookies from websites where users have researched luxury cars. The present system identifies users who have signed up for a test drive, determine their profiles (e.g., male interested in golf and gourmet cooking, infrequent clickers) and then find other users with similar profiles.

The present system and method provides improved learning and constantly refines prediction of users' behavior at an individual level. Information used for audience targeting includes content from web pages, server logs, and transcripts.

FIG. 1 illustrates an exemplary system level architecture for use with the present system, according to one embodiment. A user 101 having a browser views a webpage hosted by a server 108. An RIB system 106 receives biddings from one or more bidders 107. Bidders 107 and/or advertisement systems 105 select an appropriate advertisement and place the selected advertisement to the user 101 on a webpage of the server 108. In one embodiment, The RTB system 106 provides logs of web pages visited by potential customers using their user ID or any other user-specific information. This information is used by other systems in the data processing system 109 and stored in a data storage system to analyze individual users' behavioral patterns and responsiveness to advertisement campaigns.

FIG. 2 illustrates an exemplary flow chart for collecting content consumed by users, according to one embodiment. Content consumed by users in a trade zone across time is collected in several ways. One embodiment creates an inventory of consumed content by user from several sources 201. Exemplary inventory sources include yet are not limited to web pages associated with impressions visible by real-time bidding exchanges, purchased server logs, mobile apps, television programming transcripts (and other video sources), and on-demand video selections. In one embodiment, the content consumed by users is stored in a data storage system (202) allowing for further uses without impeding the real-time content collection, such as a real-time bidding process. As an example, web pages associated with impressions visible by real-time bidding exchange system 106 are stored and associate raw content collected (203). This storage also contains user ID and allows for creation of user profiles. Once raw content is collected, it is processed, including classified by topics (204) while preserving contextual metadata. The content and processed classifications are associated with original source data and user (205) and stored in the data storage system (202).

The data processing system 109 analyzes the consumption profile data and predicts users who are likely to take a desirable action. The data processing system 109 further clusters predicted users into meaningful groups, and reports a list of users for targeting to bidders 107 on a fine grained, informative level.

In one embodiment, the bidder 107 does not require cookies on user 101's web browser, therefore user privacy is maintained. Users are identified by their user ID, the time of their actions, or any other user-specific information without requiring cookies.

Every time bidders 107 see a user 101 and an available URL, the data processing system 109 records the time, user ID, and URL. The topic assignment process may be performed by a topic assignment server and the data processing system 109 communicates with the server to identify the category of the user's URL. Other useful information collected by the data processing system 109 includes the amount of traffic produced by the user, the time of day the user browses the URL, the user's search queries, location and historical advertisement click rates.

Another useful source of data is observed events on advertisers' confirmation pages. It is noted that observed events may be in various forms. In one embodiment, the present system and method uses a cookie ID and a time stamp that are sent when a user performs an action. The present system and method matches such events to the user topic/time of day consumption. Examples of these observed events include user clicking, visiting a desired page, downloading a coupon, calling, filling out an application form, watching a video, starting or completing a purchase and/or interacting with an application. In one embodiment, these observed events are captured in real time or captured offline and provided by the advertiser. These observed events provide one way of placing users into desirable and undesirable targeting segments.

In one embodiment, using observed event data in addition to a random selection of other users, a classifier is constructed using ensembles of regression trees to find new cookies (or users) that are likely to perform the action in the future. Bidders then focus on winning advertisement space for this new audience for precise targeting. According to one embodiment, the present system and method uses the new audience to improve current pools of users who are identified by other models and refines the audience targeting.

According to one embodiment, the present system and method learns from users globally. Users who have common interests are clustered into groups. The present system and method provides daily advertising impressions to groups of users of a certain interest that match a campaign goal, even without observed events from an advertisers' site. This leads to invaluable insights for advertisers. The present system and method provides advertisers with very specific but anonymous information about the type of users that consume their product. The consumption information includes information regarding which users are real consumers and not robots. As a result, advertisers spend less money for advertisement campaigns and reduce spending wasted on impressions that are not seen by human users.

FIG. 3 illustrates an exemplary flow chart for audience targeting, according to one embodiment. The bidding system 107 tracks web pages visited by users (301). The bidding system 107 may track web pages visited by users before, after, during or without regard to an advertisement campaign. The bidding system 107 can also receive users' data from another system. The web pages and tracked users' behaviors may be obtained from offline historical data or online data from on-going advertisement campaigns in real-time. Those web pages visited by users are categorized into topics (302). The topics may be used to derive interests of users who will be consuming an advertisement categorized under the topics. Once categorized, the topics are mapped to users in a trade zone (or a geographical area) of a bidder's interest (303). If the advertisement campaign to run targets users nationwide, the mapping may be applied to the trade zone defined as the whole nation. The data processing system 109 continuously learns the users' responses (304) and their response information is used to refine the categorization and classification of users. The data processing cluster 109 records responsive users' ID, time of action, and URL (305). The data processing system 109 identifies potential users who are likely to respond well to a particular advertisement campaign based on users' profile matching according to an interest profile learned from the responsive users of the advertisement campaign (306)

FIG. 4 illustrates an exemplary computer architecture that may be used for the present system, according to one embodiment. The exemplary computer architecture may used for implementing one or more components described in the present disclosure including, but not limited to, the present system. Architecture 400 includes a system bus 420 for communicating information, and a processor 410 coupled to bus 420 for processing information. Architecture 400 further includes a random access memory (RAM) (referred to herein as main memory) or other dynamic storage device 425, coupled to bus 420 for storing information and instructions to be executed by processor 410. Main memory 425 also may be used for storing temporary variables or other intermediate information during execution of instructions by processor 410. Architecture 400 may also include a read only memory (ROM) and/or other static storage device 426 coupled to bus 420 for storing static information and instructions used by processor 410.

A data storage device 427 such as a magnetic disk or optical disc and its corresponding drive may also be coupled to architecture 400 for storing information and instructions. Architecture 400 can also be coupled to a second I/O bus 450 via an I/O interface 430. A plurality of I/O devices may be coupled to I/O bus 450, including a display device 443, an input device (e.g., an alphanumeric input device 442 and/or a cursor control device 441).

The communication device 440 allows for access to other computers (e.g., servers or clients) via a network. The communication device 440 may include one or more modems, network interface cards, wireless network interfaces or other interface devices, such as those used for coupling to Ethernet, token ring, or other types of networks.

A system and method for audience targeting has been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

We claim:

1. A computer-implemented method comprising:
logging content visited by a first group of users;
categorizing the content into a set of topics;
mapping the set of topics to a plurality of users in a trade zone; and
identifying a second group of users from the plurality of users based on profile matching of the second group of users with the first group of users according to a topic of an advertisement campaign.

2. The computer-implemented method of claim 1, wherein the profile matching is accomplished by fitting a classifier between observed events taken by the first group of users and interest profiles of the first group of users.

3. The computer-implemented method of claim 1 further comprising learning responses of the first group of users.

4. The computer-implemented method of claim 3, wherein the responses of the first group of users comprise clicking, visiting a desired page, downloading a coupon, calling, filling out an application form, watching a video, starting or completing a purchase and interacting with an application.

5. The computer-implemented method of claim 3 further comprising obtaining the responses of the first group of users from a real-time bidding (RTB) system.

6. The computer-implemented method of claim 1 further comprising recording time, user ID, and URL of the first group of users.

7. The computer-implemented method of claim 6 further comprising deriving the set of topics of the content based on the time, user ID, and URL of the first group of users.

8. The computer-implemented method of claim 7 further comprising obtaining an amount of traffic produced by the first group of users, a time of day the first group of users browse the URL, search queries of the first group of users, location and historical advertisement click rates.

9. The computer-implemented method of claim 1 further comprising aggregating the content into users' interest and behaviors.

10. The computer-implemented method of claim 1 further comprising clustering the second set of users into a group with a common interest.

11. The computer-implemented method of claim 1 further comprising providing a list of the second set of users to a bidder.

12. A non-transitory computer readable medium having stored thereon computer-readable instructions, and a processor coupled to the non-transitory computer readable medium, wherein the processor executes the computer-readable instructions to:
log content consumed by a first group of users;
categorize the content into a set of topics;
map the set of topics to a plurality of users in a trade zone; and
identify a second group of users from the plurality of users based on profile matching of the second group of users with the first group of users according to a topic of an advertisement campaign.

13. The non-transitory computer readable medium of claim 12, wherein the profile matching is accomplished by fitting a classifier between observed events taken by the first group of users and interest profiles of the first group of users.

14. The non-transitory computer readable medium of claim 12, wherein the processor executes the computer-readable instructions to learn responses of the first group of users.

15. The non-transitory computer readable medium of claim 14, wherein the responses of the first group of users comprise clicking, visiting a desired page, downloading a coupon, calling, filling out an application form, watching a video, starting or completing a purchase, and interacting with an application.

15. The non-transitory computer readable medium of claim 14, wherein the responses of the first group of users are obtained from an RTB system.

17. The non-transitory computer readable medium of claim 12, wherein the processor executes the computer-readable instructions to record time, user ID, and URL of the first group of users.

18. The non-transitory computer readable medium of claim 17, wherein the processor executes the computer-readable instructions to derive the set of topics of the content based on the time, user ID, and URL of the first group of users.

19. The non-transitory computer readable medium of claim 18, wherein the processor executes the computer-readable instructions to obtain an amount of traffic produced by the first group of users, a time of day the first group of users browse the URL, search queries of the first group of users, location and historical advertisement click rates.

20. The non-transitory computer readable medium of claim 12, wherein the processor executes the computer-readable instructions to aggregate the content into users' interest and behaviors.

21. The non-transitory computer readable medium of claim 12 wherein the processor executes the computer-readable instructions to cluster the second set of users into a group with a common interest.

22. The non-transitory computer readable medium of claim 12 wherein the processor executes the computer-readable instructions to provide a list of the second set of users to a bidder.
